(19) United States
(12) Patent Application Publication
(10) Pub. No.: US 2009/0319696 A1
(43) Pub. Date: Dec. 24, 2009

(54) METHOD AND APPARATUS FOR CONFIGURING AND CONTROLLING CLIENT DEVICE

(75) Inventor: Sung-joo KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/255,909

(22) Filed: Oct. 22, 2008

(30) Foreign Application Priority Data
Jun. 23, 2008 (KR) 10-2008-0059061

(51) Int. Cl. G06F 3/00

(52) U.S. Cl. 710/14

(57) ABSTRACT

Provided is a method of allowing a host apparatus such as a personal computer (PC) to control a client apparatus such as a printer by using a virtual storage device and a virtual folder. In the method, if a mode of the client apparatus is set as a virtual storage device, the client apparatus is connected to the host apparatus via a network. Then, when the host apparatus recognizes the client apparatus as a virtual storage device, a file received in a virtual folder by a user performing an operation of copying the file into the virtual folder is processed by performing a function linked to the virtual folder. Accordingly, it is possible to use the client apparatus by easily connecting it to the host apparatus.

### CROSS-REFERENCE TO RELATED PATENT APPLICATIONS

This application claims the benefit of Korean Patent Application No. 10-2008-0059061, filed on Jun. 23, 2008, in the Korean Intellectual Property Office, the disclosure of which is incorporated herein in its entirety by reference.

### BACKGROUND OF THE INVENTION

1. Field of the Invention

The present device relates to a method and apparatus capable of allowing a host apparatus, e.g., a personal computer (PC), to recognize a client apparatus, e.g., a printer, as a virtual storage device and controlling the client apparatus by using a virtual folder that is set in the client apparatus, in order to easily connect the client apparatus to the host apparatus without installing a device-dedicated driver.

2. Description of the Related Art

In order to connect a peripheral such as a printer (hereinafter referred to as a ‘client apparatus’) to an apparatus such as a personal computer (PC) (hereinafter referred to as a ‘host apparatus’), the host apparatus must perform a preparation process, e.g., installation of a driver dedicated to the client apparatus, in order to recognize and use the client apparatus.

That is, conventionally, when connecting a client apparatus to a host apparatus in order to use the client apparatus, the host device requests the client apparatus which is connected thereto via a network to transmit the name and class information of the client apparatus, and then, the client apparatus responds with the information to the host apparatus so that the host apparatus can recognize the client apparatus according to its the device class. For example, if the client apparatus is a printer, it is recognized as the printer. Then, the host apparatus requests a user to install a device-dedicated driver, and the user installs a device dedicated driver, e.g., a printer driver, which is provided from the manufacturer of the client apparatus, into the host apparatus. The user can use functions, e.g., a printing function, of the client apparatus by using the device dedicated driver and a related application.

As described above, in order to use a client apparatus in a host apparatus, an additional device-dedicated driver must be installed. However, such an installation is a complicated process that is time-consuming and requires a user to have a basic knowledge and to make various inputs (interactions) in order to successfully complete the installation. Also, it is difficult and complicated for general users to execute a driver having many functions and a dedicated application.

### SUMMARY OF THE INVENTION

The present invention provides a method and apparatus for allowing a client apparatus, e.g., a printer, to be recognized as a virtual storage device by a host apparatus, e.g., a personal computer (PC), and allowing a user to control the client apparatus by using a virtual folder that is set in the client apparatus, in order to easily connect the client apparatus to the host apparatus without installing a device-dedicated driver.

The present invention also provides a method and apparatus for configuring a client apparatus by setting a virtual folder that is to be used in the client apparatus and functions that are to be linked to the virtual folder.

According to an aspect of the present invention, there is provided a method of configuring a client apparatus, the method including setting a device mode of the client apparatus, setting a function to be linked to a virtual folder that is to be used in the client apparatus, and generating the virtual folder.

The setting of the device mode may include setting the device mode as either an original device mode corresponding to a device class of the client apparatus or a virtual storage device mode, according to user input.

The client apparatus may include a plurality of virtual folders, and the virtual folders respectively correspond to a plurality of functions of the client apparatus.

During the setting of a function to be linked to a virtual folder, a function to be linked to the virtual folder may be set according to user input, and during the generating of the virtual folder, a name may be generated for the virtual folder according to the user's manual editing or according to an automatic folder name generation rule of the client apparatus.

The automatic folder name generation rule of the client apparatus may automatically generate the name of the virtual folder according to the name of the function set by user input.

The client apparatus may be a printer.

The function to be linked to the virtual folder may include one of a printing function, a saving function, and a transfer function.

The printing function may include options configuring printing paper size and an output mode.

The options may include detailed options including margin setting, resolution setting, printing quality setting, and double-faced printing setting.

According to another aspect of the present invention, there is provided a method of controlling a client apparatus, the method including connecting the client apparatus to a host apparatus via a network; transmitting information regarding a set device mode of the client apparatus to the host apparatus in order to allow the host apparatus to recognize the client apparatus; receiving a file from the host apparatus in a virtual folder generated in the client apparatus; and performing a function linked to the virtual folder to which the received file belongs.

During the connecting of the client apparatus to the host apparatus via the network, one of USB (Universal Serial Bus), UPnP (Universal Plug and Play), Bluetooth, and IEEE 1394 may be used.

If the device mode is a virtual storage device, the transmitting of the information regarding the set device mode of the client apparatus to the host apparatus, includes receiving a request for a device name and device class information of the client apparatus from the host apparatus, and responding with a device name and device class information corresponding to a storage device to the host apparatus.

The receiving of the file from the host apparatus may include receiving the file by a user performing an operation of copying the file into the virtual folder of the client apparatus.

According to another aspect of the present invention, there is provided a client apparatus including a device configuration unit configuring the client apparatus; and a device control unit controlling the client apparatus. The device configuration unit includes a device mode setting unit setting a device mode of the client apparatus; and a virtual folder and function setting unit setting a function to be linked to a virtual folder that is to be used in the client apparatus, and generating the virtual folder. The device control unit includes a network connection unit connecting the client apparatus to the host apparatus via a network; a device recognition unit transmitting information regarding the set device mode of the client apparatus to the host apparatus in order to allow the host apparatus to recognize the client apparatus; a file communication unit receiving a file from the host apparatus in a virtual folder generated in the client apparatus; and a function process unit performing a function linked to the virtual folder to which the received file belongs.

According to another aspect of the present invention, there is provided a computer readable recording medium having recorded thereon a computer program for executing a method of configuring a client apparatus, the method including setting a device mode of the client apparatus, setting a function to be linked to a virtual folder that is to be used in the client apparatus, and generating the virtual folder.

### BRIEF DESCRIPTION OF THE DRAWINGS

The above and other features and advantages of the present device will become more apparent by describing in detail exemplary embodiments thereof with reference to the attached drawings in which:

FIG. 1 is flowchart illustrating a process of configuring a client apparatus according to an exemplary embodiment of the present invention;

FIG. 2 illustrates user interface screens for generating a virtual folder and setting a function to be linked to the virtual folder according to an exemplary embodiment of the present invention;

FIG. 3 is flowchart illustrating a process of controlling a client apparatus according to an exemplary embodiment of the present invention;

FIG. 4 is a view illustrating an exchange of information between a host apparatus and a client apparatus for device recognition when a device mode is set as a virtual storage device, according to an exemplary embodiment of the present invention;

FIG. 5 illustrates the result of a host apparatus exploring virtual folders in a client apparatus when the host apparatus recognizes the client apparatus as a storage device, according to an exemplary embodiment of the present invention; and

FIG. 6 is a block diagram of a client apparatus according to an exemplary embodiment of the present invention.

### DETAILED DESCRIPTION OF EXEMPLARY EMBODIMENTS

The present invention relates to a host apparatus and a client apparatus connected via a network. The host apparatus, such as a personal computer (PC), can recognize the client apparatus as soon as it is connected to the client apparatus through a device driver recognition function, e.g., plug and play, which is provided by an operating system (OS). More specifically, the host apparatus transmits to the client apparatus a request for the device name and device class information of the client apparatus as soon as the client apparatus is connected to the host apparatus. The client apparatus responds with the device name and class of a storage device rather than the original device name and class of the client apparatus. Thus, the host apparatus recognizes the client apparatus as a virtual storage device rather than a device itself such as, for example, a printer.

The client apparatus has a plurality of virtual folders respectively corresponding to its unique functions. The virtual folders are predetermined via user input. For example, if the client apparatus is a printer, a folder named ‘Print’ exists as a virtual folder in a storage device. Alternatively, a user may predetermine folder names, such as ‘Print_Photo’, ‘Print_Landscape’, and ‘Print_Color’, which correspond to various functions of the client apparatus.

Then, since the host apparatus recognizes the client apparatus as a general storage device, a user of the host apparatus can search for a virtual folder of the client apparatus via an explorer provided by the OS and copy a file to the virtual folder so that the predetermined function corresponding to the virtual folder can be performed. For example, when the user performs an operation of copying a file that is to be printed to the virtual folder ‘Print’ of the client apparatus, the client apparatus receives the file as if the file was directly copied to the storage device and further performs a printing function linked to the virtual folder ‘Print’.

Hereinafter, exemplary embodiments of the present invention will now be described in greater detail with reference to the accompanying drawings. The same reference numerals represent the same elements throughout the drawings. In the drawings, the size of each constitutional element may be exaggerated for clarity.

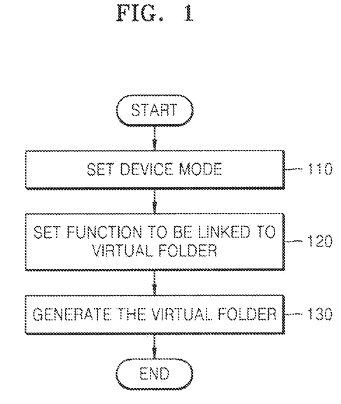

FIG. 1 is a flowchart illustrating a process of configuring a client apparatus according to an embodiment of the present invention. This process is necessary when the client apparatus is initially used but a user can change settings of the client apparatus by performing the process at any time even while the client apparatus is being used.

In operation 110, a device mode of the client apparatus is determined. According to an embodiment of the present invention, the device mode of the client apparatus is determined as either the original device mode corresponding to the device class of the client apparatus or a virtual storage device mode, according to user input. Thus, a conventional method of using a client apparatus, in which the client apparatus is recognized as it is, e.g., as a printer, by a host apparatus and then the host apparatus is requested to install a device-dedicated driver, can also be used according to the user's selection. If a device mode is set as the original device mode, the host apparatus must perform a preparation process, e.g., installation of a driver dedicated to the client apparatus, in order to recognize and use the client apparatus. If the device mode is set as a virtual device mode, a user can control the client apparatus by using a virtual storage device and a virtual folder without additionally installing a device-dedicated driver as described above.

The user can input the device mode of the client apparatus via a user interface, such as a menu or a direct button.

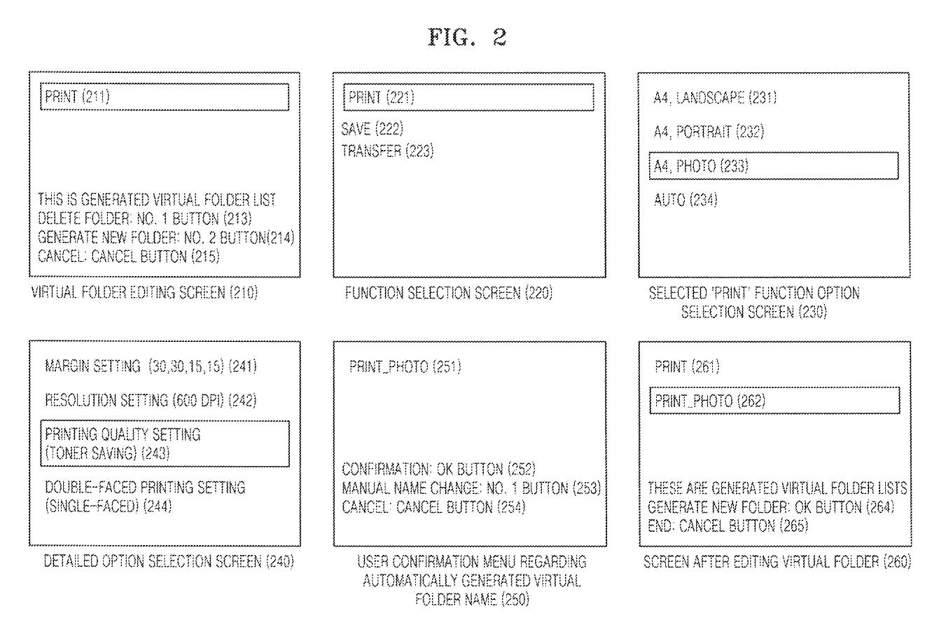

In operation 120, a function that is to be linked to the host apparatus is set and stored in the form of a virtual folder. The client apparatus may have a plurality of virtual folders each corresponding to a combination of a device function and an option. The user can edit the virtual folders via a user interface such as illustrated in FIG. 2 and select the details of a function linked to each of the virtual folders as options. A process of setting a function to be linked to a virtual folder will be described later with reference to FIG. 2.

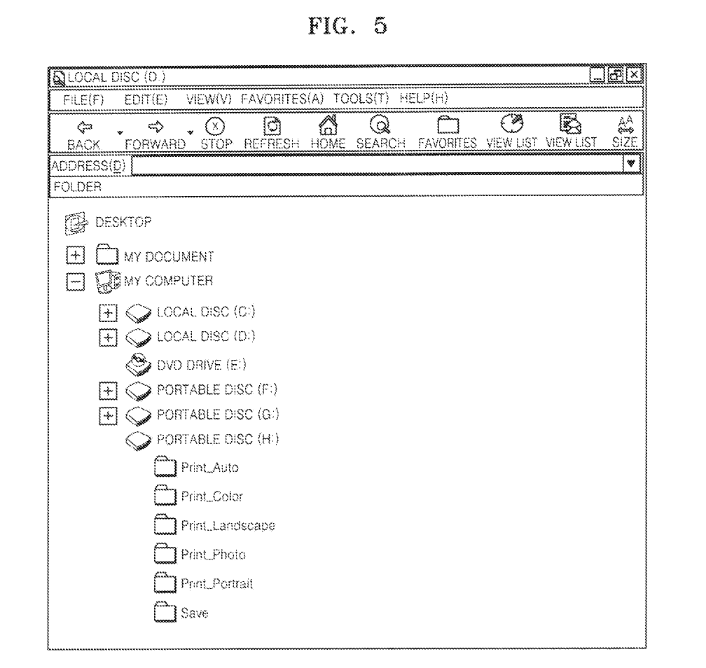

In operation 130, a virtual folder is generated having a name according to the user's manual editing or according to an automatic folder name generation rule of the client apparatus. For example, if there is a rule to automatically generate a folder name from a combination of a function and an option, the virtual folder named ‘Print_Photo’ is automatically generated when the user combines a ‘Print’ function with a ‘Photo’ output mode as an option. The user may use the automatically generated folder name or manually edit a folder name by performing a manual name change operation. The generated folder name can later be used to search for a virtual storage device, as will be described later with reference to FIG. 5.

FIG. 2 illustrates user interface screens via which a virtual folder of a client apparatus and a function to be linked to the virtual folder are set according to an embodiment of the present invention.

A user presets and stores a function, which is to be used while being linked to a host apparatus, in the form of a virtual folder, via user interface screens as illustrated in FIG. 2 which are provided from the client apparatus.

A screen 210 presents a virtual folder list, e.g., a ‘print’ 211, which is output via a menu screen. If a user desires to create a new virtual folder, the user clicks a ‘generate new folder’ item 214 in the menu screen, selects a desired function, e.g., a ‘print’ function 221, from a screen 220, and edits options of the selected function in screens 230 and 240. For example, after selecting the ‘print’ function 221, the user may select options by clicking, for example, an ‘A4, photo’ item 233 and a ‘set printing quality (toner saving)’ item 243. Options set via the screens 220 through 240 may be different according to a service provided by the client apparatus.

The name of a virtual folder is generated according to a user's manual editing or according to an automatic generation rule of the client apparatus. For example, if the automatic generation rule prescribes a combination of a function and an option, when the user combines a ‘Print’ function with a ‘Photo’ output mode as an option, a virtual folder is automatically generated in the name of ‘Print_Photo’ 251. The user may use the automatically generated folder name by clicking a ‘confirmation’ item 252 or manually edit a folder name by pressing a ‘manual name change’ item 253. If the user clicks the ‘confirmation’ item 252, the folder name, ‘Print_Photo’ 251 can be used when searching for a virtual storage device (see FIG. 5 for more details). A screen 260 is a user interface screen presenting virtual folder lists 261 and 262 after generating a new virtual folder, e.g., a ‘Print_Photo’ 262.

As described above, a user configures a client apparatus by setting a virtual folder and a function to be linked to the virtual folder beforehand.

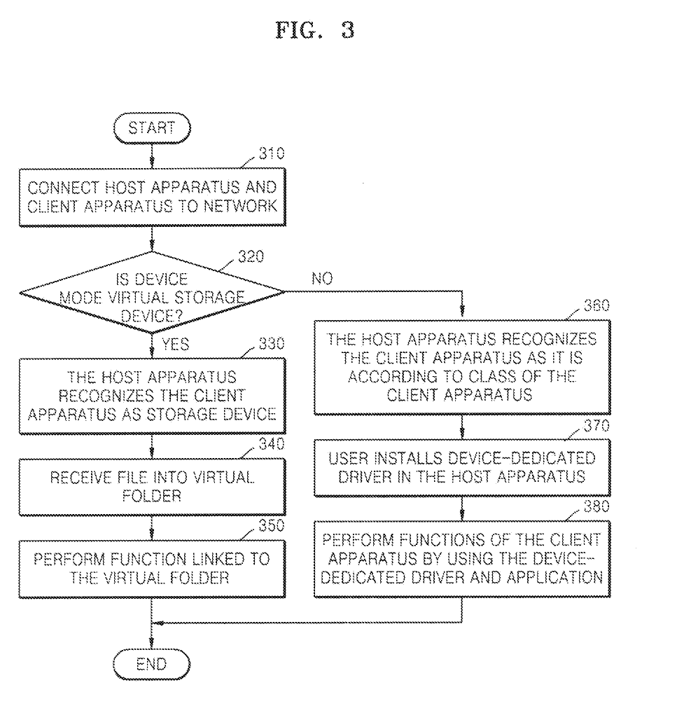

FIG. 3 is a flowchart illustrating a process of controlling a client apparatus after configuring the client apparatus as illustrated in FIGS. 1 and 2, according to an embodiment of the present invention.

In operation 310, a host apparatus and a client apparatus are connected via a network. In this case, various networking technologies, such as a universal serial bus (USB), universal plug and play (UPnP), Bluetooth, and IEEE 1394, which are generally used to build a personal area network (PAN), can be used. The present invention is characterized in that a client apparatus is controlled by allowing a host apparatus to recognize it as a virtual storage device, and therefore, various network standards providing a storage device as a type of application device can be used.

In operation 320, the client apparatus determines whether a device mode set by a user is a virtual storage device. As described above, a device mode of the client apparatus is preset as either the original device mode corresponding to the class of the client apparatus, e.g., a printer, or a virtual device mode, according to user input.

If the client apparatus mode is the virtual storage device, the method proceeds to operation 330. In operation 330, since the device mode of the client apparatus is the virtual storage device, the client apparatus receives a request for its device name and device class information from the host apparatus, and responds with the device name and class corresponding to a storage device to the host apparatus. The host apparatus receiving the device name and class information recognizes the client apparatus as a storage device.

In operation 340, a user copies a file into a virtual folder of the client apparatus recognized as a storage device, through which the client apparatus receives the file into the virtual folder. The virtual folder may be automatically generated when the user edits a function to be linked to the virtual folder and an option via a user interface screen, as described above with reference to FIG. 2.

In operation 350, the function linked to the virtual folder, e.g., printing, to which the received file belongs is performed.

If it is determined in operation 320 that the client apparatus mode is not the virtual storage device, the method proceeds to operation 360. Operation 360 is a preparation process for device recognition and usage, e.g., installing a driver dedicated to the client apparatus, which is a conventional process performed when using a client apparatus.

In operation 360, the host apparatus requests the client apparatus which is connected thereto via the network to provide its device name and device class information, and the client apparatus responds with the original device name and device class information to the host apparatus. Thus, the host apparatus recognizes the client apparatus as it is, according to the class of the client apparatus. For example, if the client apparatus is a printer, the host apparatus recognizes it as the printer.

In operation 370, after recognizing the client apparatus, the host apparatus requests the user to install a device-dedicated driver. The user installs in the host apparatus a device-dedicated driver, e.g., a printer driver, provided by the manufacturer of the client apparatus.

In operation 380, the user uses the function, e.g., printing, of the client apparatus, by using the device-dedicated driver and an application.

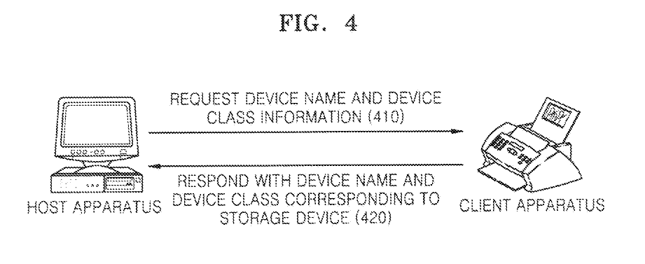

FIG. 4 is a view illustrating an exchange of information between a host apparatus and a client apparatus for device recognition when a device mode is set as a virtual storage device according to an embodiment of the present invention.

In operation 410, the host apparatus requests the client apparatus to provide the device name and device class information of the client apparatus. In operation 420, the client apparatus responds with the device name and class corresponding to a storage device to the host apparatus. The host apparatus receiving the device name and class recognizes the client apparatus as the storage device, and accesses and controls the client apparatus via a virtual folder of the client apparatus, which is set as described above with reference to FIG. 3.

FIG. 5 illustrates the result of a host apparatus exploring virtual folders in a client apparatus when the host apparatus recognizes the client apparatus as a storage device, according to an embodiment of the present invention. The folder name of each of the explored virtual folders is automatically generated from a combination of a function and an option edited by a user as illustrated in the screen 250 of FIG. 2 but may be manually edited by the user.

The user explores the virtual folders in the client apparatus and transmits a file to the client apparatus by copying the file into one of the virtual folders, as illustrated in operation 340 of FIG. 3. The client apparatus performs the function linked to the virtual folder to which the received file belongs, as illustrated in operation 350 of FIG. 3.

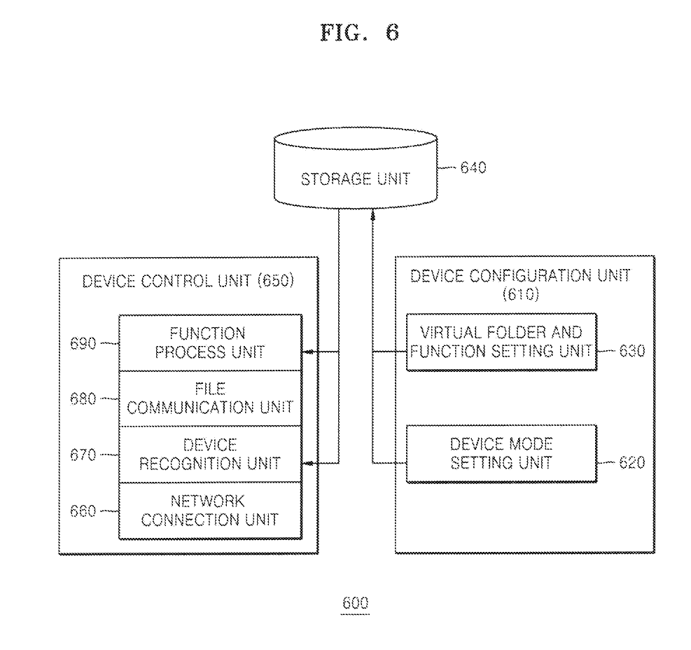

FIG. 6 is a block diagram of a client apparatus according to an embodiment of the present invention. The client apparatus illustrated in FIG. 6 is controlled using a virtual storage device and a virtual folder.

The client apparatus includes a device configuration unit 610, a device controller unit 650, and a storage unit 640. The device configuration unit 610 includes a device mode setting unit 620 and a virtual folder and function setting unit 630. The device control unit 650 includes a network connection unit 660, a device recognition unit 670, a file communication unit 680, and a function process unit 690.

The device mode setting unit 620 sets a device mode of the client apparatus as either the original device mode, e.g., a printer, which corresponds to the device class of the client apparatus or a virtual device mode, according to user input. If the device mode is set as the original device mode, a conventional process performed when using a client apparatus, that is, a preparation process for device recognition and usage, e.g., installing a driver dedicated to the client apparatus, is required. If the device mode is set as a virtual device mode, the client apparatus is controlled using a virtual storage device and a virtual folder.

If the user inputs a function linked to the virtual folder and an option to the virtual folder and function setting unit 630, the virtual folder and function setting unit 630 generates a virtual folder according to an automatic generation rule or according to the user's manual editing and manages the virtual folder. For example, if the automatic generation rule prescribes a combination of a function and an option, a folder name is generated from a combination of a function and an option.

The storage unit 640 stores information regarding the mode of the client apparatus, which is set by the device mode setting unit 620, and information regarding virtual folder lists, which is set by the virtual folder and function setting unit 630. The storage unit 640 may be a storage medium, such as a flash memory or a hard disc.

The network connection unit 660 connects the host apparatus and the client apparatus via a network. In this case, various networking technologies, such as a universal serial bus (USB), universal plug and play (UPnP), Bluetooth, and IEEE 1394, which are generally used to build a personal area network (PAN), can be used.

The device recognition unit 670 receives a request for its device name and device class information from the host apparatus, as illustrated in operation 410 of FIG. 4, reads the information regarding the mode of the client apparatus from the storage unit 640, and responds with the device name and class information corresponding to a storage device to the host apparatus, when the mode of the client apparatus is set as a virtual storage device mode, as illustrated in operation 420. The host apparatus receiving the device name and class information from the client apparatus recognizes the client apparatus as a storage device. If the mode of the client apparatus is set as the original device mode, the client apparatus transmits the original device name, e.g., a printer, and class information to the host apparatus, and the host apparatus recognizes the client apparatus as it is, that is, for example, as a printer.

The file communication unit 680 receives a file into a virtual folder of the client apparatus recognized as a storage device when the user copies the file into the virtual folder.

The function process unit 690 recognizes a function, e.g., a printing function, which is linked to the virtual folder to which the received file belongs via the storage unit 640, and performs the function.

According to the above embodiments of the present invention, a user can skip a device recognition process and a driver installation process, which conventionally have to be performed between a host apparatus and a client apparatus, thereby simplifying a process of connecting devices with each other and increasing device portability. Also, the user can easily perform a function linked to a virtual folder by copying a file into the virtual folder, thereby increasing user convenience.

Also, the user can easily manage and use frequently used functions and options when using the client apparatus by editing a function and option to be linked to each virtual folder and storing them in units of virtual folders beforehand.

The invention can be embodied as computer readable codes on a computer readable recording medium and computer readable transmission medium. The computer readable recording medium is any data storage device that can store data, which can be thereafter read by a computer system. Examples of the computer readable recording medium (including all devices having information process functions) include read-only memory (ROM), random-access memory (RAM), CD-ROMs, magnetic tapes, floppy disks, and optical data storage devices. Examples of the computer readable transmission medium include carrier waves (e.g., transmission through the Internet).

While this invention has been particularly shown and described with reference to exemplary embodiments thereof, it will be understood by those of ordinary skill in the art that various changes in form and details may be made therein without departing from the spirit and scope of the invention as defined by the appended claims.

What is claimed is:

1. A method of configuring a client apparatus, the method comprising:
setting a device mode of the client apparatus;
linking, to a virtual folder, a function that is to be used in the client apparatus; and
generating the virtual folder.

2. The method of claim 1, wherein the setting of the device mode comprises setting, according to user input, the device mode as either an original device mode corresponding to a device class of the client apparatus or a virtual storage device mode.

3. The method of claim 1, wherein the client apparatus comprises a plurality of virtual folders, and the virtual folders respectively correspond to a plurality of functions of the client apparatus.

4. The method of claim 1, wherein during the linking of the function to the virtual folder, a function to be linked to the virtual folder is set according to user input, and
during the generating of the virtual folder, a name is generated for the virtual folder according to the user's manual editing or according to an automatic folder name generation rule of the client apparatus.

5. The method of claim 4, wherein the automatic folder name generation rule of the client apparatus automatically generates the name of the virtual folder according to the name of the function set by user input.

6. The method of claim 1, wherein the client apparatus is a printer.

7. The method of claim 6, wherein the function to be linked to the virtual folder comprises one of a printing function, a saving function, and a transfer function.

8. The method of claim 7, wherein the printing function comprises options for configuring printing paper size and an output mode.

9. The method of claim 8, wherein the options comprise detailed options including at least one of margin setting, resolution setting, printing quality setting, and double-faced printing setting.

10. A method of controlling a client apparatus, the method comprising:
connecting the client apparatus to a host apparatus via a network;
transmitting information regarding a current device mode of the client apparatus to the host apparatus in order to allow the host apparatus to recognize the client apparatus;
receiving a file from the host apparatus into a virtual folder generated in the client apparatus; and
performing a function linked to the virtual folder to which the received file belongs.

11. The method of claim 10, wherein during the connecting of the client apparatus to the host apparatus via the network, one of USB (Universal Serial Bus), UPnP (Universal Plug and Play), Bluetooth, and IEEE 1394 is used.

12. The method of claim 10, wherein, if the device mode is a virtual storage device, the transmitting of the information regarding the current device mode of the client apparatus to the host apparatus, comprises receiving a request for a device name and device class information of the client apparatus from the host apparatus, and responding with a device name and device class information corresponding to a storage device to the host apparatus.

13. The method of claim 10, wherein the receiving of the file from the host apparatus comprises receiving the file by an user performing an operation of copying the file into the virtual folder of the client apparatus.

14. A client apparatus comprising:
a device configuration unit which configures the client apparatus; and
a device control unit which controls the client apparatus,
wherein the device configuration unit comprises:
a device mode setting unit which sets a device mode of the client apparatus; and
a virtual folder and function setting unit which sets a function to be linked to a virtual folder that is to be used in the client apparatus, and which generates the virtual folder; and
wherein the device control unit comprises:
a network connection unit which connects the client apparatus to the host apparatus via a network;
a device recognition unit which transmits information regarding the set device mode of the client apparatus to the host apparatus in order to allow the host apparatus to recognize the client apparatus;
a file communication unit which receives a file from the host apparatus in a virtual folder generated in the client apparatus; and
a function process unit which performs a function linked to the virtual folder to which the received file belongs.

15. The client apparatus of claim 14, wherein the device mode setting unit sets, according to user input, the device mode as either an original device mode corresponding to a device class of the client apparatus or a virtual storage device mode.

16. The client apparatus of claim 14, wherein the client apparatus comprises a plurality of virtual folders, and the virtual folders respectively correspond to a plurality of functions of the client apparatus.

17. The client apparatus of claim 14, wherein the virtual folder and function setting unit sets the function to be linked to the virtual folder according to user input, and generates the virtual folder having a name according to the user's manual editing or according to an automatic folder name generation rule of the client apparatus.

18. The client apparatus of claim 17, wherein the automatic folder name generation rule automatically generates the name of the virtual folder according to the name of the function set by user input.

19. The client apparatus of claim 14, wherein the client apparatus is a printer.

20. The client apparatus of claim 19, wherein the function to be linked to the virtual folder comprises one of a printing function, a saving function, and a transfer function.

21. The client apparatus of claim 20, wherein the printing function comprises at least one of options for configuring a printing paper size and an output mode.

22. The client apparatus of claim 21, wherein the options comprise detailed options including at least one of margin setting, resolution setting, printing quality setting, and double-faced printing setting.

23. The client apparatus of claim 14, wherein the network connection unit uses one of USB (Universal Serial Bus), UPnP (Universal Plug and Play), Bluetooth, and IEEE 1394.

24. The client apparatus of claim 14, wherein, if the device mode is a virtual storage device, the device recognition unit receives a request for a device name and device class information of the client apparatus from the host apparatus and responds with a device name and device class information corresponding to a storage device to the host apparatus.

25. The client apparatus of claim 14, wherein the file communication unit receives the file by a user operation to copy the file into the virtual folder of the client apparatus.

26. A computer readable recording medium having recorded thereon a computer program for executing a method of configuring a client apparatus, the method comprising:
setting a device mode of the client apparatus;
linking, to a virtual folder, a function that is to be used in the client apparatus; and
generating the virtual folder.
